(19) United States
(12) Patent Application Publication
(10) Pub. No.: US 2014/0019298 A1
(43) Pub. Date: Jan. 16, 2014

(54) SYSTEMS AND METHODS FOR UNIVERSAL ONLINE CHECKOUT

(71) Applicant: Shopzilla, Inc., Los Angeles, CA (US)

(72) Inventors: Philippe Suchet, San Francisco, CA (US); Siva Chandrasekar, Cupertino, CA (US)

(21) Appl. No.: 13/940,986

(22) Filed: Jul. 12, 2013

Related U.S. Application Data
(60) Provisional application No. 61/670,852, filed on Jul. 12, 2012.

(51) Int. Cl. G06Q 30/06

(52) U.S. Cl. CPC G06Q 30/0633
USPC 705/26.8

(57) ABSTRACT

Systems and methods for providing secure online shopping and, more particularly, systems and methods of electronic commerce using a universal shopping cart and a managed spider application that is adapted to maintain integration with each e-tailer-specific virtual shopping cart and to recreate on the corresponding e-tailer's website a most-recent shopping session state of the cart if integration between the two is interrupted.

### CROSS-REFERENCE TO RELATED APPLICATIONS

This application claims priority to and the benefit of U.S. Provisional Patent Application No. 61/670,852 filed on Jul. 12, 2012, which is incorporated herein in its entirety by reference.

### FIELD OF THE INVENTION

Systems and methods for providing secure online shopping and, more particularly, systems and methods of electronic commerce using a universal shopping cart that, at checkout, holds items from a plurality of online e-tailers.

### BACKGROUND OF THE INVENTION

Retail was revolutionized in the 1990s with the introduction of secure online shopping, i.e., “e-commerce,” whereby consumers could suddenly purchase items wherever they had access to the Internet. Initially, electronic merchants (“e-tailers”) dealt with many challenges, among which included developing a method to collect product selections as well as shipping and payment information from the consumer. E-tailers ultimately settled on providing web forms that required consumers to input shipping and billing address and credit card information as well as other personal information such as name, email address, and phone number. Traditionally, these forms have been fairly lengthy, sometimes spanning as many as ten web pages or more and often requiring consumers to enter the same information multiple times. Although consumers found this checkout process cumbersome, many considered it a small inconvenience in light of the overall convenience of shopping online.

Approximately ten years later, the invention of the smart phone sparked a new online shopping revolution: mobile shopping, i.e., “m-commerce.” Using portable smart phones and other mobile devices—and, subsequently, the tablet—consumers could, e.g., using a web browser application, access the Internet, and subsequently e-commerce websites, anywhere they went. Although, m-commerce provided e-tailers with many new opportunities, it also highlighted multiple inefficiencies in the existing e-commerce experience. For example, from a consumer's perspective, two of the more egregious inefficiencies were form length and the numerous checkout process steps. Indeed, what was once considered a minor hindrance in light of the overall convenience of shopping online had become a glaring obstacle in e-commerce, whether on mobile devices or personal computers. In an increasingly productive society, consumers prefer to have a simple, speedy checkout. While recognizing this long-felt need, e-tailers and online payments companies, such as PayPal, have attempted to solve this problem over the past few years but with little success.

Some e-tailers have attempted to solve the speedy and less cumbersome checkout problem by reducing information redundancy and/or by allowing consumers to create a secure account on the e-tailer's website. For example, many e-tailers now permit consumers to “check the box” if a consumer's shipping address and billing address are the same, eliminating the need to enter the same address more than once. Notwithstanding, even if the consumer wants the product shipped to his/her billing address—which often is not the case—this does little to reduce the time it takes to checkout.

Furthermore, some e-tailers enable consumers to create a purportedly secure account on the e-tailer's website. Consumers provide shipping and billing information during a first transaction with a specific e-tailer, which securely stores the data, e.g., in a secure memory that is accessible only upon entry of a username and passcode established by the consumer. During a future transaction—and assuming the consumer is able to recall both the username and the passcode—when the consumer desires to make another purchase from the same e-tailer, the consumer can populate shipping, billing, and similar information fields simply by entering the pre-established username, e.g., an email address, and passcode.

Although creating such an account on an e-tailer's website removes much of the friction during purchasing, the benefits are confined to that discrete e-tailer's website. However, many if not most online shopping consumers shop at multiple online stores. With one-to-one relationships between the consumer and a discrete e-tailer, creating an account for every e-tailer would be nightmarish and, moreover, managing every account, e.g., remembering every username and passcode used, would be insanely difficult. More problematically, were a consumer to move to a new address or acquire a new credit card, he/she would need to update each individual e-tailer account before the consumer could again make a purchase from that discrete e-tailer.

Some online payment services provide a quasi-universal payment option that e-tailers may integrate into their website. Indeed, an online “wallet” allows consumers to leverage purchases across multiple e-commerce sites. Typically, a consumer creates an account with a payment service provider to which the consumer's credit card information can be attached or associated. Subsequently, when a consumer with an online wallet from a payment service provider wishes to checkout from an e-tailer's website, the consumer must traverse through the e-tailer's normal checkout flow of forms and fields until the consumer is required to enter credit card information. At this point in the transaction, if the e-tailer supports the payment service associated with the consumer's online wallet, the consumer may choose to pay using the consumer's payment service account. For example, typically, the consumer may enter a username and passcode and then continue through the remainder of the e-tailer's checkout process until the purchase has been transacted. For consumers, although online payment services can be beneficial when purchasing across multiple e-tailers, it remains a partial solution because the reach of the payment services only applies to credit card information. Consumers must still navigate through and fill out the rest of the e-tailer's checkout webpages.

Furthermore, to effect these transactions, e-tailers are required to do some technical work, e.g., developing Application Programming Interfaces (APIs); adding multiple lines of code; and so forth, to their website to enable consumers to checkout via these payment services. Many e-tailers, however, do not have the technical expertise needed to develop such software. As a result, the e-tailers must either pay someone to do it for them or simply not support online payment services. Even if an e-tailer is capable of developing the necessary software, it may take time and resources away from advancing other areas of their website and business as a whole.

Others have suggested universal or multi-site shopping cart systems that are designed to provide consumers with a single shopping cart interface at a single location from which the consumer may purchase items from a plurality of e-tailer websites. Disadvantageously, these systems require active e-tailer participation during the transaction, which, in its broadest sense, suggests a server-client relationship for transferring requests and data in response to those requests. Hence, the universal shopping cart serves as a pass-through proxy, serving requested web pages from the e-tailer's website to the consumer. When the consumer requests an e-tailer's shopping cart(s), the universal shopping cart is displayed instead. When the consumer indicates a desire to purchase the items in the universal shopping cart, the contents of the universal shopping cart are re-created on the e-tailer's shopping cart(s) and an order is placed using billing and shipping information previously saved and associated with the universal shopping cart.

Accordingly, it would be advantageous to provide a simplified, shortened universal checkout process for the consumer's convenience, e.g., using a universal shopping cart, but that does not place excess burden on e-tailers. More specifically, it would be advantageous to provide a universal shopping cart and universal shopping experience that does not require active e-tailer cooperation to complete an order, removing the e-tailers almost entirely from the transaction short of shipping the item(s) ordered.

### SUMMARY OF THE INVENTION

Various aspects of the invention provide techniques and supporting systems that enable universal online checkout on a website that is not maintained or controlled by any particular e-tailer(s), i.e., a third party or application partner website, and in which active cooperation from an e-tailer or the e-tailer's website is not necessary or provided in a manner that is standardized across all supported e-tailers. In some embodiments, the third-party or application partner website can also be a mobile, e.g., WAP-enabled, website as well as a mobile application. The system may include a set of application programming interfaces (“APIs”) and a unified data model. For example, the system may include a consumer interface that collects and displays purchase information in a standard manner and a “spider” application that maintains integration with the individual e-tailers and that collects product features. Products are identified by Universal Resource Locators on the participating e-tailer's website or through Universal Product Identification Numbers, thus allowing the system to locate the product quickly and simply using a URL. The products are “collected” or “extracted” from numerous e-tailer-specific websites and placed into a universal shopping cart where a single purchase transaction at the consumer's end completes the purchases at each e-tailer-specific website. Session data for each e-tailer-specific website may also be stored for each e-tailer-specific website such that incomplete purchases and/or interrupted shopping sessions are maintained for subsequent completion, even long after the e-tailer-specific website may have canceled or removed the details from the shopping session from its records.

In a first aspect of the invention, a universal system for online commerce is disclosed. The system includes a data processing device(s) that is adapted to execute computer-readable instructions contained in a memory. The data processing device(s) provide a consumer interface(s) to an application partner website or mobile application at which a consumer can navigate to and through a webpage(s) that is maintained and controlled by the system, separate from the e-tailer-specific website and/or e-tailer webpage(s), for the purpose of displaying purchase and product information extracted from the e-tailer-specific website or e-tailer webpage; provide a universal shopping cart in the application partner website or mobile application that, likewise, remains separate from an on-line e-tailer's shopping cart, for storing an item(s) offered for sale; and transact a single checkout transaction with the consumer and multiple e-tailers.

In some embodiments of the system, the data processing device may create and maintain a discrete virtual shopping cart for each online e-tailer that has an item(s) stored in the consumer's universal shopping cart. In yet another embodiment, the universal shopping cart of the application partner website or mobile application provides a summary of products in each of the discrete virtual shopping carts for each online e-tailer for a period of time. In still further embodiments, the product is identified and searchable on any e-tailer's website using at least one of Universal Resource Locators and Universal Product Identification Numbers, e.g., Universal Product Codes (UPC), International Article Number (EAN), Japanese Article Numbers (JAN), Global Trade Item Number (GTIN), and an internal, e-tailer-specific product number.

In other embodiments, the system may include a spider application programming interface that (i) maintains integration with discrete e-tailers and retains product information for a period of time; (ii) transacts the single checkout transaction with the consumer; and (iii) in response to instructions from the consumer, completes a purchase transaction with each discrete e-tailer. Preferably, the spider application programming interface may maintain for a period of time session data of a transaction state for each session with a corresponding e-tailer. Advantageously, the period of time may be pre-established, configured by the consumer or configurable by the system. More preferably, the spider application programming interface may be adapted to regenerate the transaction state for any shopping session that has expired, that has been canceled or that otherwise has been removed from records of the corresponding e-tailer. More specifically, the spider application programming interface may be adapted to regenerate the transaction state and to update the transaction state of the shopping session in accordance with real time product information, e.g., product availability, product color options, product size options or costs, extracted from the corresponding e-tailer.

In a second aspect of the present invention, a method of completing a single checkout purchase transaction between an online consumer and multiple online e-tailers is disclosed. The method includes providing a consumer with access to an application partner website(s) or mobile application(s) at which the consumer may view purchase and product information that is either stored in a cache memory and/or that is extracted from an online e-tailer's website; providing a universal shopping cart on the application partner website(s) or mobile application(s) for storing and managing an item(s) for sale by an online e-tailer; and providing real time product information, e.g., product availability, product descriptions, product reviews, return policies, coupon codes, product images, color options, size options, and costs, until a transaction session is completed. Preferably, providing access to an application partner website or mobile application and providing a universal shopping cart on the same are done without active cooperation from an online e-tailer.

In some implementations, purchase and product information may be provided based on a consumer request using at least one of Universal Resource Locators and Universal Product Identification Numbers, e.g., Universal Product Codes (UPC), International Article Number (EAN), Japanese Article Numbers (JAN), Global Trade Item Number (GTIN), and an internal, e-tailer-specific product number.

In other embodiments, the method may include a step of completing the purchase transaction with each online e-tailer(s). For example, completing the purchase transaction may include retrieving a last purchase session state attributed to a discrete, e-tailer-specific virtual shopping cart; validating the last purchase session state by ascertaining product availability with the online e-tailer; confirming completion of the purchase transaction; extracting order confirmation information from the online e-tailer; and providing the consumer with extracted order confirmation information. In yet another embodiment, the method may include the step of applying any discounts or promotional coupons to the checkout purchase transaction. Discounts or promotional coupons may originate from many sources. For example, discounts or promotional coupons may be advertised on the online e-tailer's website. Alternatively or in addition, the consumer, the application partner, and/or some other third party may provide discounts or promotional coupons that the consumer enters and/or be prompted to enter at some point during the shopping experience, before the final transaction.

In still other embodiments, providing a universal shopping cart on the application partner website(s) or mobile application(s) may include maintaining a virtual shopping cart with each online e-tailer; aggregating estimated costs from all of the virtual shopping carts; and regenerating on a discrete virtual shopping cart a last purchase session state of the discrete, e-tailer-specific virtual shopping cart after the last purchase session state has been invalidated or interrupted. In some implementations, regenerating a last purchase session state may include assigning a globally-unique identification reference number (GUID) to each instance of a shopping session state attributed to a discrete, e-tailer-specific virtual shopping cart; storing in memory the shopping session state of the discrete, e-tailer-specific virtual shopping cart using the GUID; retrieving the shopping session state of the discrete, e-tailer-specific virtual shopping cart by using the GUID; recreating the last purchase session state for the discrete, e-tailer-specific virtual shopping cart with the corresponding online e-tailer using the retrieved shopping session state data; and validating the last purchase session state by ascertaining product availability with the corresponding online e-tailer.

In a third aspect, an article of manufacture for completing a single checkout purchase transaction between an online consumer and online e-tailers is disclosed. In some embodiments, the article of manufacture comprises embedded computer-readable program portions for completing a single checkout purchase transaction between an online consumer and a plurality of e-tailers, the program portions comprising instructions for providing an application partner website(s) or mobile application(s) at which a consumer can navigate to and through a webpage(s) that displays purchase and product information that has been either stored in a cache memory or extracted from an online e-tailer's website; providing a universal shopping cart on the application partner website(s) or mobile application(s) for storing and managing an item offered for sale by an online e-tailer; and providing real time product information until a transaction session is completed. Preferably, providing access to an application partner website(s) or mobile application(s) and providing a universal shopping cart on the same are done without active cooperation from the online e-tailer.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows an illustrative embodiment of one aspect of a universal system for online commerce in accordance with the present invention.

FIG. 2 shows an illustrative embodiment of an aspect of a user interface shown during various steps of making a purchase transaction in accordance with the present invention.

FIG. 3 shows an illustrative embodiment of a process for signing up for a new account for logging into an existing account with a discrete e-tailer in accordance with the present invention.

FIG. 4 shows an illustrative embodiment of a process for requesting and receiving product information from a discrete e-tailer in accordance with the present invention.

FIGS. 5A-5D show various illustrative images of examples of product information in a user interface and interactive options in accordance with the present invention.

FIG. 6 shows an illustrative embodiment of a process for adding items to a universal shopping cart and for resurrecting an interrupted shopping cart session in accordance with the present invention.

FIG. 7 shows one aspect of a shopping cart retrieval/resurrection process in accordance with the present invention.

### DETAILED DESCRIPTION OF THE INVENTION

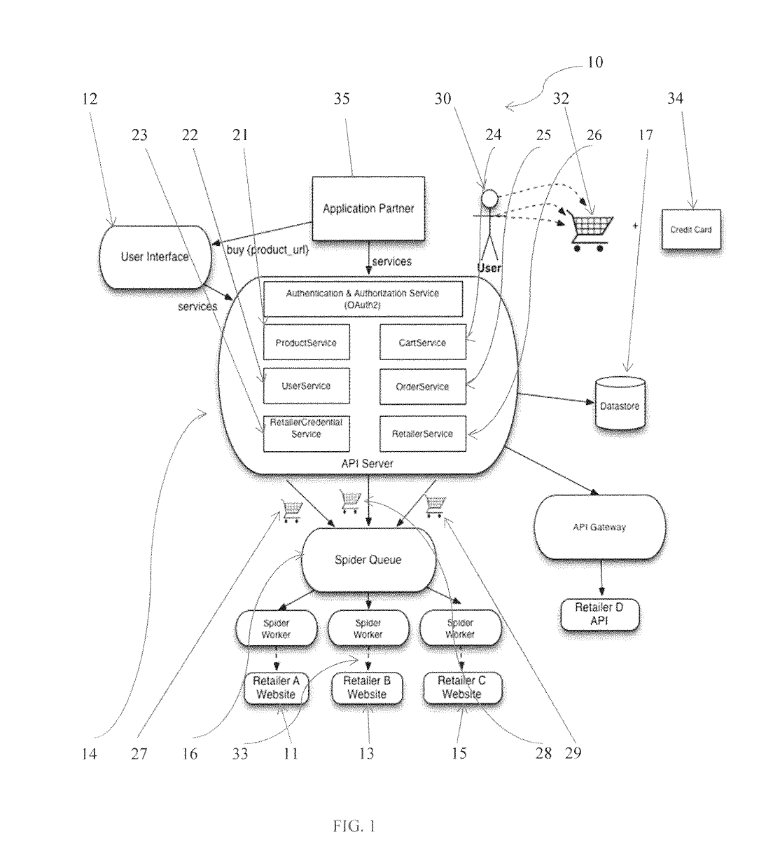

Referring to FIG. 1, an illustrative embodiment of a universal system 10 for online commerce is shown. Various embodiments of the system 10 of the present invention may include at least one processing device that is structured and arranged to execute computer-readable instructions to provide at least three core components: a user interface 12, an API 14, and a managed “spider” application 16. The user interface 12 may be a collection of interfaces that may be used to preview and buy products or goods and services from supported e-tailing partners. Preferably, the user interface 12 is integrated into an application partner website or mobile application 35, which, in its broadest definition, may refer to a site that is not maintained or controlled by any particular e-tailer(s) and in which active cooperation from an e-tailer's website is not necessary or provided. Hence, the application partner website or mobile application 35 actively extracts information and data from an e-tailer-specific website or web page without active cooperation from the e-tailer or the e-tailer's website. Advantageously, the architecture of the present invention enables a local application executed on an electronic device to maintain for a period of time at least one transaction involving a number of items from multiple e-tailers in a single state until the consumer opts to purchase some subset of the items. The period of time may be pre-established, may be user configurable, and/or may be configurable by the system and may last for several hours, for several days, for several weeks, and so forth. Necessarily, this may involve providing, as necessary, real-time adjustments to take into account any changes in item availability, item descriptions, item reviews, return policies, coupon codes, item images, item color options, item size options, and so forth due to the lapse of the period of time.

The user interface 12 (“UI”) may integrate with supported e-tailer partners to provide a complete consumer experience during the purchase of products from the supported e-tailers. The API 14 may include a set of services that enable and enhance the consumer experience without requiring active cooperation from the e-tailer or the e-tailer's website. These services may include, for example, acquiring product information from various supported e-tailers, acquiring product availability from various supported e-tailers, acquiring product options from various e-tailers, acquiring product description information, acquiring product reviews, acquiring return policies, acquiring coupon codes, acquiring product images, adding products to or including products in a universal shopping cart 32, and effecting a single checkout transaction. In one aspect of the API 14, the acquisition of product information includes searching for products, e.g., on a supported e-tailer's website, using a product Universal Resource Locators (URL) and/or a Universal Product Identification Number, such as a Universal Product Code (UPC), an International Article Number (EAN), a Japanese Article Number (JAN), a Global Trade Identification Number (GTIN), an internal, e-tailer-specific product number, and so forth. Advantageously, the system 10 allows consumers 30 to find a desired product simply using a URL, UPC, EAN, JAN, GTIN, an internal, e-tailer-specific product number, and the like. The managed spider application 16 integrates with supported e-tailers to look up product features, to ascertain product availability, to maintain cart sessions, and to enhance checkout. Reliance simply on a product URL, UPC, EAN, JAN, GTIN, internal, e-tailer-specific product number, and the like facilitates integrating the system 10 with online referral services.

### User Interface

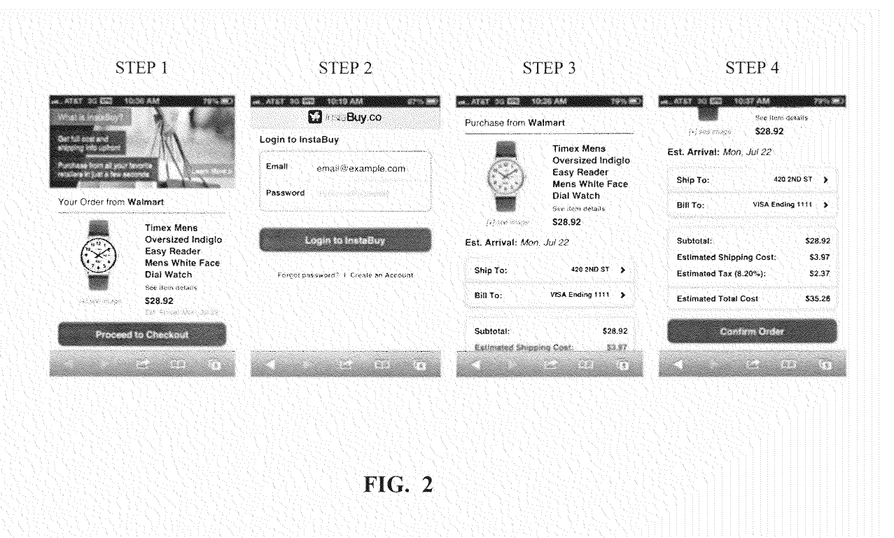

UIs 12 are well-known to the art and need not be described in detail. In its simplest form, a UI 12 may be implemented by a processor on a computing device, which may include embodiments as mobile platforms (FIG. 2), e.g., mobile telephones, cellular telephones, personal data assistants, computer tablets, computer pads, and the like; or as stationary platforms (not shown), e.g., network appliances, personal computers, workstations, mainframes, networked clients, servers, media servers, application servers, database servers, web servers, and network equipment, such as load balancers, routers, and switches. Typically, a UI 12 may include an HTML5 or similar application to provide a standard consumer experience for consumers 30 who wish to buy products from supported e-tailers. Referring again to FIG. 1, using the UI 12, consumers 30 initially sign up for or establish a single (“universal”) account 34, e.g., via an application partner website or mobile application 35, that may be used universally across the platform. The universal account 34 may include shipping/billing and payment information for the consumer 30. The universal account 34 may also store supported e-tailer-specific check-out information for the consumer's benefit, e.g., an e-tailer-specific membership number, identification number, login, passcode, passcode hint, and so forth, after the consumer 30 has completed a purchase transaction with the supported e-tailer using the system 10 and entered the check-out information. As a result, during future purchase transactions with the same supported e-tailer, the system 10 can automatically populate required access and check-out fields without requiring the consumer 30 to re-enter the data. Advantageously, the universal account 34 may be secure, which is to say that it may only be accessed by the consumer 30, e.g., using an identification username and passcode, which can be pre-established.

After a consumer 30 has signed up for or established a universal account 34 within the system 10, the consumer 30 then may proceed to shop for products on the websites of supported e-tailers (STEP 1, FIG. 2). Preferably, a shopping session may include using, inputting or entering the URL of a desired product, good or service. As stated previously, reliance simply on a product URL, UPC, EAN, JAN, GTIN, internal, e-tailer-specific product number, and the like facilitates integrating the system 10 with online referral services, which can open up revenue-generating opportunities for the application partner 35, who, ostensibly, may receive added revenue from supported e-tailers for directing a consumer 30 to their products. For example, supported e-tailers may construct a simple URL similar to the exemplary URLs below:

https://m.xyz.co/buy?product_url=<product_url_in_e-tailer_website> or

https://m.xyz.co/add_to_cart?product_url=<product_url_in_e-tailer_website>

to guide the consumer 30 through a purchase process using the system described herein. Alternatively, in lieu of a URL, the UPC, EAN, JAN, GTIN, an internal, e-tailer-specific product number, and the like of the product may be used. Once the consumer 30 has found an item he/she desires to purchase, he/she may add the product to the consumer's universal shopping cart 32, e.g., by depressing a button, by clicking on a cursor, and the like. If the consumer 30 has not already done so prior to adding an item to the user's universal shopping cart 32, he/she may have to login to the universal account 34 (STEP 2, FIG. 2). Having logged into his/her universal account 34, the product may be added to the universal shopping cart (STEP 3, FIG. 2). The consumer 30 may then be given the option to proceed to checkout or to continue shopping. In the case of the latter, to continue shopping, the consumer's UI 12 may return to the supported e-tailer's webpages or may go to any supported e-tailer's webpages. In the case of the former, to checkout, the consumer 30 may be presented with a list of items to be purchased and the cost of each item, which may include shipping costs, state or other taxes, and the like. At this point, the user 30 may be asked to confirm his/her order (STEP 4, FIG. 2).

### Application Programming Interface

Each application programming interface (“API”) 14 may include a combination of REST-based services that support JSON, JSONP, XML, and similar formats, to enable and enhance the consumer shopping and checkout experience. Exemplary sets of services that may be provided by the API 14 can include product services 21, consumer services 22, e-tailer credential services 23, cart services 24, order services 25, and e-tailer services 26. Those of ordinary skill in the art can appreciate that other services not enumerated in this disclosure may also be provided in the API(s) 14 or that the API(s) 14 may include a subset of services both enumerated and not enumerated. The list of services is provided for illustrative purposes only and is not to be construed as limiting the scope of the invention. The enumerated services are described below.

ProductService 21 may include services to acquire (“Get”) product information, e.g., using URL, UPC, EAN, JAN, GTIN, an internal, e-tailer-specific product number, and the like to identify the product and to extract product information about the product using its location on an e-tailer's website, from supported e-tailers; to acquire product options, e.g., product colors, product sizes, etc.; to obtain product coupon codes; to acquire images of the product; to acquire return policies; to acquire product description information, to acquire product reviews, and to acquire product availability information. Optionally, ProductService 21 may enable consumers 30 to provide (“Leave”) product feedback that may be routed to the supported e-tailers. Methods of and means for making calls to acquire product information and to leave a message are known to the art and do not require further description.

UserService 22 may include services that “Create” new consumer accounts 34; that “Add” consumer shipping/billing/payment information to created accounts 34, including created accounts with specific, supported e-tailers; and, for those supported e-tailers that require consumer account 34 creation, that “Create/Add” e-tailer-specific credentials. Methods of and means for creating and adding to consumer accounts and address e-tailer credentials are known to the art and do not require further description.

RetailerCredentialService 23 may include services designed to “Sign-up” consumers 30 for new e-tailer accounts and/or designed to “Verify” login of existing e-tailer accounts. Sign-up and verification services are known to the art and do not require further description.

CartService 24 may include services that “Create” a universal shopping cart 32; that enable consumers 30 to “Add” products to the universal shopping cart 32, to include quantity and selected value for each product option; that “Add Billing, Shipping and E-tailer Credentials” to each universal shopping cart 32, and that “Estimate” the cost—and ultimately calculate the real cost—to purchase all of the items contained in the universal shopping cart 32. Methods of and means for providing a virtual shopping cart are known to the art and do not require further description.

OrderService 25 may include self-explanatory services necessary to complete a transaction. For example, self-explanatory services may include “Checkout an existing cart,” “Check status of existing order,” and provide a “List of existing orders.”

RetailerService 26 may include self-explanatory services to “Get list of supported e-tailers,” to provide consumers 30 with shopping options and to “Get list of sign-up fields to be filled by consumer,” which may be necessary to create a new account for a particular supported e-tailer.

### Managed “Spider” Application

The managed spider application 16 may be structured and arranged to manage the integration of the resources associated with individual supported e-tailers with the other elements of the system 10. Advantageously, integration may not require—and preferably does not require—e-tailers to actively cooperate in the integration or in the transaction aside from internally processing and fulfilling the order and shipping the items to the consumer 30. Typically, in operation, once a consumer 30 inputs a URL corresponding to an item to buy, e.g., using a cloud-based browser, the spider application 16 determines, first, if the URL may already be stored in a cache memory 17 for such data. The spider application further may determine whether or not the URL corresponds to a supported e-tailer and, if so, whether or not the URL points to a product page or to an item on that product page supported at the e-tailer's website 11, 13 or 15. If so, the spider application 16 may be adapted to extract pertinent product information from the discrete e-tailer's webpage 11, 13 or 15 and return the pertinent, extracted product information to the consumer 30. The extracted product information may include, without limitation, the item price, brand, available colors, a size listing, description information, product reviews, return policies, coupon codes, product images, and so forth. During these initial steps of the spider application 16 process, the e-tailer's role in the online shopping event remains passive, which is to say that the managed spider application 16 has done all of the work.

The spider application 16 may further initiate requests of the e-tailer's website 11, 13 or 15, for example, to ascertain other product options, availability based on the type, color, and/or size of item requested, and so forth. The spider application 16 may call and extract all possible product options, the corresponding possible values, and the combination of option values that are currently available. For example, if a consumer 30 desires to purchase a shirt that is available in multiple sizes and colors, the spider application 16 is adapted to return not only all of the available colors and sizes, but, also, all of the combinations of colors and sizes that are currently available, i.e., the intersection of the subsets of available sizes and of available color. If the spider application 16 determines after acquiring these product data that a desired item is not available for purchase from the targeted e-tailer, e.g., in a desired color and size, the spider application 16 may be adapted to prepare and transmit to the consumer's processing device an exception message explaining, for example, that the desired item cannot be purchased at the present time from the targeted e-tailer using the service. At this point, the spider application 16 may refer the consumer 30 to another supported e-tailer who has or may have the desired item. In another illustrative example of its capabilities, the spider application 16 may also be adapted to provide an exception message to the consumer 30 after ascertaining that its connection 33 with an e-tailer's website 11, 13 or 15 has been interrupted or otherwise compromised.

One novel feature of the spider application 16 is that the spider application 16 may also be adapted to maintain, e.g., stored in a data-storing device 17, cart shopping session data corresponding to each e-tailer website 11, 13, and 15 having at least one item in the consumer's universal shopping cart 32. This capability is particularly useful if, for example, a connection 33 is interrupted or if an e-tailer's virtual shopping cart (not shown) has expired or otherwise stopped storing data for an online purchase. For example, after an item has been added to the universal shopping cart 32, the item may also be added to a virtual shopping cart that is maintained by the e-tailer, outside of the system 10. Preferably, the item may remain in the universal shopping cart 32 and in a corresponding e-tailer virtual shopping cart until the item has been deleted from the transaction or the transaction has been consummated.

Advantageously, because one of these two events may occur at some appreciable time in the future, should the e-tailer's shopping cart expire or otherwise stop storing or saving purchase data—as they are pre-designed to do—or should the connection 33 between the e-tailer's website 11, 13 or 15 and the spider application 16 be interrupted, the spider application 16 may be adapted to regenerate or re-create the expired or deleted e-tailer's virtual shopping cart on the e-tailer's website 11, 13 or 15, which is to say, retrieve data pertaining to the stored session and, moreover, resurrect the e-tailer's virtual shopping cart to the state in which it was immediately prior to the expiration or disconnection. This process is discussed in greater detail below. Hence, whenever a shopping session at an e-tailer's website 11, 13 or 15 times-out for any reason, the spider application 16 starts afresh, e.g., using stored session data uniquely corresponding to a distinct e-tailer virtual shopping cart, re-adding each of the items “lost” due to the expiration/disconnection to a new virtual shopping cart on the e-tailer's website 11, 13 or 15.

### Account Creation and Login

Having described some embodiments of the system 10, some processes that may be executed via the system 10 will now be described. Before a first-time consumer 30 can complete an online purchase transaction, the consumer 30 may be required to create an individual account with the application partner 35, with one or more of the supported e-tailers with whom the consumer 30 has had no previous transactions, and with one or more supported e-tailers with whom the consumer 30 is a first-time user. As described above, although they may vary from e-tailer to e-tailer, individual accounts typically contain information necessary to complete the purchase transaction. Online e-tailers may allow consumers 30 to buy products as a guest and not require consumers 30 to sign up. This is the simplest to handle with the system 10. Other online e-tailers, however, may require each consumer 30 to register and provide some basic information about themselves, i.e., to create an account, prior to consummating a purchase transaction. Because the system 10 may be structured and arranged to capture and to store most or, in some cases, all necessary data to create a consumer account with the application partner 35, this facilitates creation of parallel accounts with a discrete online e-tailer as these data are used to populate appropriate fields associated with subsequent checkouts from the discrete e-tailer.

For consumers 30 who have never shopped or have never registered an account with a particular supported e-tailer, the system 10 is adapted, when the e-tailer-specific website requests it, to automatically populate the e-tailer's check-out fields with the appropriate stored information. If the available data in the consumer's account 34 populates all necessary data fields for check-out with the respective e-tailer, the data can—if desired—be saved with both the e-tailer and with the system 10. Optionally, a username and/or passcode can be attributed to these data for the respective e-tailer, to facilitate future purchases with from the same e-tailer. The login username and/or passcode may apply to the check-out data stored with the e-tailer or with the application partner 35 or both. Advantageously, the e-tailer-specific login username and/or passcode—and more advantageously a plurality of e-tailer-specific usernames and/or passcodes—may be saved in the consumer's account 34, where the username(s) and/or passcode(s) could be accessed merely using the consumer's username and passcode for login with the system 10. Indeed, a consumer 30 would only have to remember a single username and/or passcode, i.e., that to the consumer's account 34, rather than the specific username and/or passcode for each specific e-tailer.

Any data field in the e-tailer specific check-out for which there is no counterpart in the consumer's account 34 would, necessarily, generate a system prompt from the consumer's account 34 to have the consumer 30 enter the missing information. Once the consumer 30 inputs these data, these data can—if desired—be saved in an e-tailer check-out account and/or in a specific e-tailer portion of the consumer's account 34. The general consumer information (data field) portion of the consumer's account 34 would also be updated automatically. Optionally, a login username and/or passcode may be attributed to these data for the discrete e-tailer, to facilitate future purchases with from the same e-tailer. The login username and/or passcode may apply to the check-out data stored with the e-tailer or with the application partner 35 or both. Advantageously, the e-tailer-specific username and/or passcode—and more advantageously a plurality of e-tailer-specific usernames and/or passcodes—may be saved in a designated portion of the consumer's account 34, where the username(s) and/or passcode(s) for a discrete e-tailer may be accessed merely using the consumer's username and passcode for the system 10. As a result, instead of having to remember login usernames and passcodes for numerous supported e-tailers, a consumer 30 only needs to remember a single username and/or passcode, i.e., that for login to the consumer's account 34.

For consumers 30 who have previously shopped on a supported e-tailer's website and, who, during a previous shopping event, created and saved a check-out profile with the particular e-tailer, the system 10, at check-out, may be adapted to prompt the consumer 30 for her unique login username and passcode information associated with the respective e-tailer. Once the consumer 30 inputs their e-tailer-specific username and passcode information, these data can be saved in the specific e-tailer portion of the consumer's account 34 so that the system 10 can automatically login the consumer 30 during a future purchase transaction via the supported e-tailer's check-out scheme.

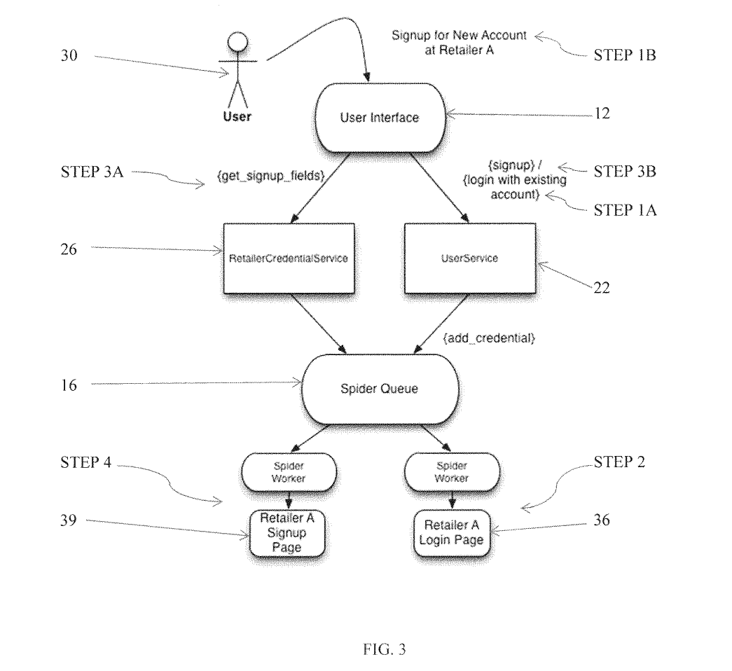

For example, if a consumer 30 desires to add and/or purchase an item offered for sale by a supported e-tailer (“Retailer A”), and Retailer A requires a consumer account to consummate the purchase transaction, the system 10 may be adapted to ascertain whether or not Retailer A login information for the consumer 30 already exists in the system 10, e.g., by searching a memory cache 17 storing data for that purpose. In the alternative or in the negative, the system 10 may be adapted, further, to query Retailer A's website 11, 13 or 15, e.g., in advance of a consumer-generated checkout demand, to determine whether or not the consumer 30 has an existing account with Retailer A. Referring to FIG. 3, if the consumer 30 has an account with Retailer A, the system 10 may be adapted to, then, prompt the consumer 30 for previously established login information; allow the consumer 30 to enter his/her current Retailer A username and Retailer A password (STEP 1A); and pass on the username and password to Retailer A (STEP 2). For example, the spider application 16 may be adapted to transmit existing account login information to Retailer A's LOGIN page 36 (STEP 2) via the UserService 22 application of the API 14.

Retailer A may then verify the username and password further populating any purchase field data with previously stored data associated with the verified username and password. Once Retailer A has verified the validity of the user by virtue of the entered username and password, the system 10 may automatically save, store, and/or update, e.g., in a cache memory 17 storing data for that purpose, the username and password attributed to Retailer A, to facilitate subsequent transactions purchases between Retailer A and the consumer 30.

Assuming that the system's query determines that the consumer 30 does not already have a Retailer A consumer account and that Retailer A requires such an account, the user interface 12 of the system 10 may be adapted to prompt the user to sign up for a new Retailer A account (STEP 1B). Sign-up is greatly simplified by having customary sign-up field data for the consumer 30, e.g., name, billing address, shipping address, telephone number, email address, payment information, and the like, immediately accessible, e.g., stored in a memory cache 17 storing data for that purpose. In such instance, the consumer may only have to input a unique username and password.

Notwithstanding the stored customary sign-up field data, the system 10 may also be adapted to ascertain which sign-up fields are required to create a new account with Retailer A (STEP 3A), e.g., via the RetailerService 26 application in the API 14. If all or less than all of the necessary sign-up field data are already accessible to the system 10, e.g., stored in a memory cache 17 storing data for that purpose, then these sign-up field data may be provided directly to Retailer A's sign-up page 39, e.g., via the spider application 10, to populate the appropriate fields in Retailer A's sign-up page 39 (STEP 4). Advantageously, this might occur automatically and with no further input required from the consumer 30. If, on the other hand, all or some portion of the necessary sign-up field data is not already accessible to the system 10, then the system 10 may require the consumer 30 to input the missing sign-up field data necessary to create and/or fill-out the Retailer A sign-up page and account 39 (STEP 3B), e.g., via the UserService 22 application in the API 14. These additional data entries may be provided to populate the appropriate fields in Retailer A's sign-up page 39 (STEP 4) and may also be added to update the customary sign-up field data required by Retailer A as well as to update the consumer's personal data.

### Shopping and Product Preview

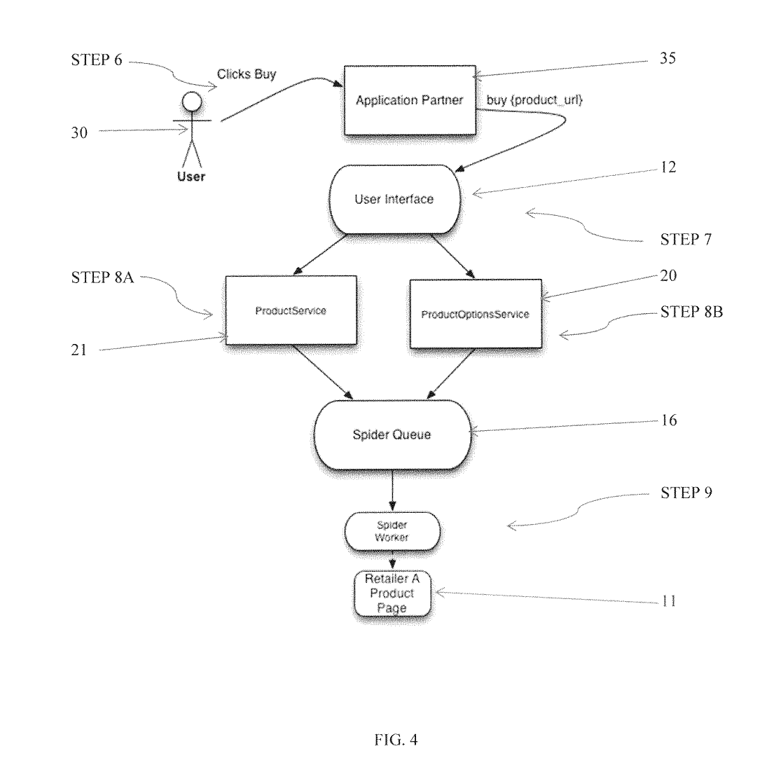

Some of the system processes include general shopping and preview of product operations. Referring to FIG. 4, in a first step, a consumer 30 may manifest her desire to purchase an item or, alternatively, to collect more information about an item, e.g., by inputting a URL, UPI, and the like (STEP 6) at any time. The system 10 then leads the consumer 30 to a product preview page, e.g., in the UI 12 (STEP 7). For example, a ProductService 21 application may acquire product information for the consumer 30 in real time (STEP 8A). More particularly, the ProductService 21 application may be adapted to search for the product and product information locally, e.g., in a cache memory 17 storing data for that purpose, or remotely via Retailer A's website 11. Preferably, a local search precedes a remote, website search. If, however, neither the product nor product information is available in the cache memory 17, the system 10 may be configured to add the desired URL/UPI to the spider application's work queue. Subsequently, the spider application 16 will search for the product information using the URL/UPI (STEP 9).

For the latter, various instantiations of the spider application 16 may use a cloud-based browser (not shown) to visit the URL/UPI at the Retailer A's website 11 and/or to extract, in real time, up-to-date product information from the same 11. The spider application 16 instantiations may be customized to work with Retailer A and may be aware of and sensitive to any changes in the Retailer A's website 11 that may result in returning incorrect information or no information at all. Advantageously, once the product information is extracted and delivered to the UI 12, the data can be stored according to the URL/UPI, e.g., in a memory cache 17 for that purpose.

The ProductService 21 application among the APIs 14 may be adapted, when prompted, to return to the UI 12 one or more of: product information, an estimated cost of shipping this product (if available), whether this product has options that needs to be customized by the consumer 30, an original price, a sale price, a discount, and so forth.

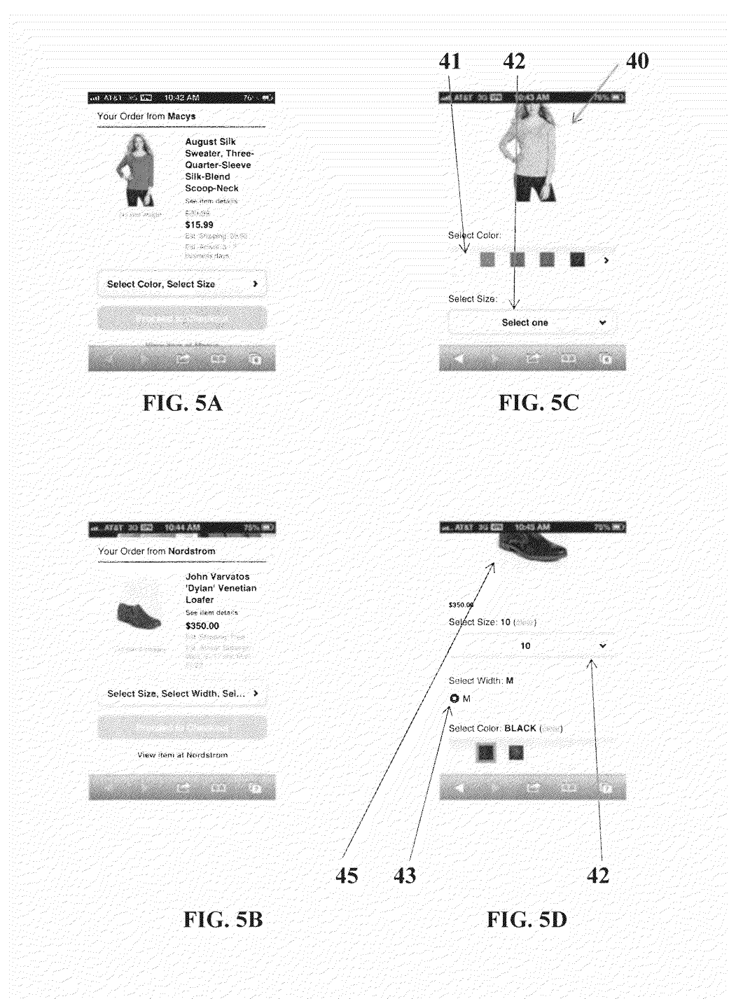

Optionally, as shown in FIG. 5A and FIG. 5B, some items—a woman's sweater 40 and footwear 45, respectively—may include consumer options, e.g., color 41, size 42, width 43, and the like, that require consumer option input to reflect his/her personal preference(s) or choice(s). As a result, in instances in which a desired item requires consumer option input, the UI 12 may be adapted to initiate another search request, e.g., to a cache memory 17 storing data for that purpose, to acquire information on possible options, their possible costs, and the availability of these options. For example, although Retailer A may offer for sale sweaters 40 (FIG. 5A) for which there are three different colors 41 and four different sizes 42 and Retailer B may offer a pair of boots 45 (FIG. 5B) for which there are two different colors 41, three different widths 43, and two different sizes 42, not all twelve possible combinations for either product 40, 45 may be available at any given moment. Consequently, when there are options, the system 10 may be structured and arranged such that the system 10, e.g., a ProductOptionsService 22 application, returns to the UI 12 for the consumer's user the set of options, all of the possible costs for each option, and the availability for each option (STEP 8B). In turn, the UI 12 may be adapted to display only those items in their many combinations that are immediately available to the consumer 30. Because availability changes in real time and, therefore, may change before the consumer 30 consummates a purchase transaction, the ProductOptionsService 20 application may be adapted to return to the UI 12 product information for each option and to do so in real time.

For example, using the same wind wear example, the ProductOptionsService 20 application may return and the UI 12 may display separate and distinct product images for each of the three color 41 options. The choices for options may either be expressed as a list of text, e.g., with respect to size 42 (P, S, M, L, XL) choices (FIG. 5C), or as a list of images, e.g., with respect to color 41 (black, brown) choices (FIG. 5D). Advantageously, the UI 12 may be adapted to remain completely neutral and impartial to the options that are provided by the e-tailer and, therefore, may be able to show options and availability for all product types in real time.

### Adding Items to the Universal Shopping Cart

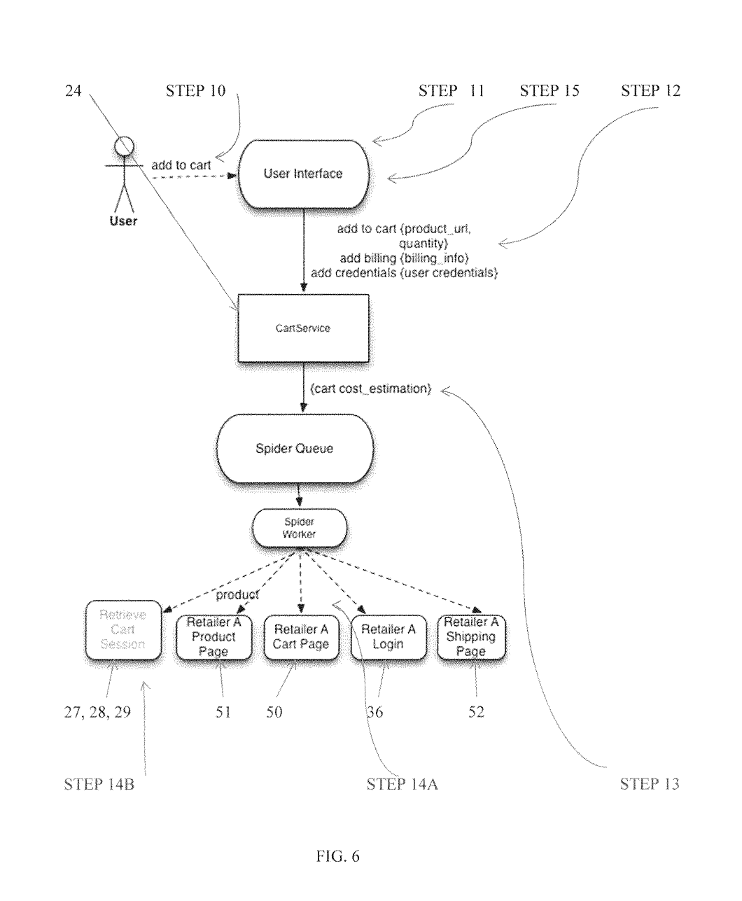

Having signed in and/or set up a new account with at least one e-tailer website 11, 13 or 15 and having requested product information for at least one item by its URL/UPI, at some point a consumer 30 is likely to manifest a desire to purchase an item, e.g., by adding the desired item to the consumer's universal shopping cart 32, e.g., by clicking on an image, cursor or icon, by touching a soft button image or icon on the user interface 12 and/or by selecting a button on an application, website or mobile site on a website page that includes a checkout prompt. Referring to FIG. 6, as a consumer 30 indicates her desire to add items to her universal shopping cart 32 (STEP 10), the system's cloud-based browser may be adapted to perform the same or substantially similar actions that otherwise would be performed by a browser application associated with an e-tailer's website 11, which may include, for example and without limitation, returning on the UI 12 (STEP 11) estimates of purchase subtotal, of shipping costs, of applicable taxes, and the like for the contents of the universal shopping cart 32. The CartService 24 application of the API 14 may be adapted to add the selected items to the universal shopping cart 32 (STEP 12), i.e., to the unique shopping cart database or memory holding the consumer-added item(s). The data added may include the number of the items desired and their unit cost. Moreover, the CartService 24 application may be adapted to rout a re-pricing request from the spider application 14 (STEP 13). Subsequently, the spider application 16 may request and/or extract the most current availability and pricing information (STEP 14A) from the corresponding e-tailer shopping cart 50, which is maintained by the e-tailer on the e-tailer's website, e.g., in any of the e-tailer's product pages 51, the e-tailer's shipping page 52, and/or the e-tailer's virtual shopping cart 50 itself. In the alternative, the spider application 16 may retrieve or extract re-pricing data from an e-tailer's website 11 using a GUID (STEP 14B), which will be discussed in greater detail below, to request the virtual shopping cart session corresponding to or associated with the unique GUID.

The processes of pricing and re-pricing the contents of the universal shopping cart 32 (STEP 13) may happen asynchronously, e.g., upon the addition or deletion of an item(s) to the unique shopping cart database or memory holding the consumer-added item(s) (STEP 12). Advantageously, although asynchronous, each of the add/delete step (STEP 12) and the pricing step (STEP 13) occurs in real time. Optionally, as part of the pricing of a product(s) in a universal shopping cart 32 (STEP 13), any merchant discounts, promotional coupons, and the like may be applied to the cost estimation so as to provide the consumer 30 with the best possible price from the e-tailer. Discounts or promotional coupons may originate from many sources. For example, discounts or promotional coupons may be advertised on the online e-tailer's website. Alternatively, the consumer, the application partner, and/or some other third party may provide discounts or promotional coupons, which the consumer would enter at some point during shopping experience, before the final transaction.

Advantageously, as more items are added to the existing universal shopping cart 32 (STEP 12), the system 10 may be configured and arranged to automatically revise the quantity and price of the contents of the universal shopping cart 32 (STEP 13). In some instances, the consumer's 30 shopping practice may cause virtual shopping cart 50 on one or more distinct e-tailer website 11, 13 or 15 to expire or otherwise be interrupted. As a result, when any of the virtual shopping carts 50 have expired, re-pricing may occur—as necessary—by restarting and returning, e.g., resurrecting, any interrupted, expired or canceled shopping session to the shopping session state that the session was in prior to the interruption or cancelation. Once the shopping session state of the corresponding virtual shopping cart 50 has been resurrected, the new item (s) may be added to the corresponding e-tailers shopping cart 50.

### Cart Re-Pricing, Cart Retrieval, and Cart Resurrection

Among the many novel aspects of the present invention remain the ability of the system 10 to provide real time re-pricing data and the ability to resurrect an interrupted, e.g., corrupted, disconnected, lapsed, expired, timed-out, and the like, shopping session between the e-tailer and the system 10. Referring to FIG. 1 and FIG. 6, the system 10 may include a plurality of shopping cart levels. For example, at the e-tailer level, i.e., on the e-tailer's website 11, 13, 15 there is a first level of virtual shopping carts 50, i.e., a shopping cart database or memory holding any consumer-added item(s) offered for sale by the e-tailer, that is maintained and controlled by the e-tailer. This first level of virtual shopping carts 50 makes available product data from the e-tailer website 11, 13, 15 to the system 10. At a third level is the universal shopping cart 32, i.e., a unique, consumer-specific shopping cart database or memory holding any consumer-added item(s). The universal shopping cart 32 is maintained and controlled by the system 10. Juxtaposed between the universal shopping cart 32 and the virtual shopping cart(s) 50 may be a second (or “interim”) level of retrieval shopping carts 27, 28, and 29 that are also maintained and controlled by the system 10. The purpose of each discrete retrieval shopping cart 27, 28, and 29 may include maintaining the current or most-recent state of a shopping session with a corresponding discrete e-tailer-specific virtual shopping cart 50 that has one or more items stored in the consumer's corresponding universal shopping cart 32. Advantageously, the system 10 may be adapted to maintain and control the interim level retrieval shopping carts 27, 28, and 29 in order to resurrect and/or retrieve an interrupted shopping cart session. Although three retrieval shopping carts 27, 28, and 29 are shown in FIG. 1, this is done for illustrative purposes only. Preferably and advantageously, there is a corresponding retrieval shopping carts 27, 28, and 29 for every unique e-tailer-specific virtual shopping cart 50 that has one or more items in the consumer's universal shopping cart 32.

Retrieval shopping carts 27, 28, and 29 serve, in one sense, as a data pass-through between the system 10 and each e-tailer-specific virtual shopping cart(s) 50. The interim level retrieval shopping carts 27, 28, and 29 may comprise a database or memory for holding historical data about consumer-added items offered for sale by the e-tailer and/or a dedicated memory for holding the same. Advantageously, this architecture may be structured and arranged to minimize the amount and degree of e-tailer active interaction or cooperation with the system 10. With the multiple levels of shopping carts, as a new item(s) is/are added to the universal shopping cart 32, the spider application 16 of the system 10 establishes, maintains, and re-establishes as necessary communication with the virtual shopping cart(s) 50 that forms part of a discrete e-tailer's website 11, 13, and 15 and aggregates the estimated cost.

Referring to FIG. 6, once an item(s) is added to the universal shopping cart 32 (STEP 10), the instance triggers a re-pricing of each item in the universal shopping cart 32. Initially, such re-pricing may manifest as a re-pricing of each and every e-tailer-specific virtual shopping cart 50 (STEP 14A) that is in communication with the system 10 at the time of the re-pricing triggering event. Once re-pricing has been completed at those e-tailer-specific virtual shopping carts 50 still in communication with the system 10, re-pricing of the universal shopping cart 32 may occur by passing these re-pricing data to the universal shopping cart 32, e.g., via the interim retrieval shopping carts 27, 28, and/or 29. For example, the system 10 may route the re-pricing request to the spider application 16 (STEP 13), which may be adapted, first, to determine whether or not communication with any of the e-tailer-specific virtual shopping cart 50 has been interrupted. If communication with the e-tailer's virtual shopping cart 50 has not been interrupted, the spider application 16 may then request or extract current and most-recent pricing data directly from each e-tailer's virtual shopping cart 50 (STEP 14A). Once passed through the interim level of retrieval shopping carts 27, 28, and 29, these data may then be provided to the UI 12 (STEP 15) for display. In short, when communication is intact, after retrieving the corresponding cart browser session (STEP 14A), the cloud-based browser re-validates that the products previously added to the virtual shopping cart 50 are still available in the e-tailer's shopping cart page 50, e.g., by requesting or extracting that information from the virtual shopping cart 50, a product page 51, and the like.

When shopping session data at the e-tailer level are unavailable, e.g., due to a an interruption, the e-tailer-specific virtual shopping cart 50 no longer exits and, therefore, cannot be retrieved as previously described. Hence, the expired or interrupted virtual shopping cart 50 must be resurrected. By design, operation of many e-tailer websites 11, 13, and 15—especially during a lengthy or interrupted shopping session—may cause a shopping cart session to terminate after a finite time period of inactivity. Typically, when a shopping session terminates, the history of the items added to the e-tailer's virtual shopping cart 50, product pricing, product availability, discounts, and other information are lost.

In one aspect of the present system 10 the history of items added to the system's universal shopping cart 32, may persist for long periods of time, even indefinitely via the interim level of retrieval shopping carts 27, 28, and 29. This may be as true for a shopping cart having a single or multiple items from a single e-tailer or for a shopping cart having a single or multiple items from multiple e-tailers. Consequently, if communication between the system 10 and a discrete e-tailer's virtual shopping cart 50 is interrupted such that product and pricing data for the shopping session event stored in that virtual shopping cart 50 has been lost, the system 10 may be adapted to resurrect that shopping session event.

For example, when communication with an e-tailer-specific virtual shopping cart 50 has been interrupted, the system 10, e.g., the spider application 16, may be adapted to retrieve automatically the most recent cart browser session internally, e.g., using the interim shopping carts 27, 28, and 29 (STEP 14B), to resurrect the interrupted virtual shopping cart(s) 50 and to re-create and update it to include current pricing and other availability data, on the e-tailer's website 11, 13, 15. In short, in the abstract, if for some reason Retailer A's virtual shopping cart 50 is no longer available or does not contain all the products previously added to it as well as to the universal shopping cart 32, the spider application 16 may initiate a new (replacement) shopping session, e.g., by clearing the sandbox of the cloud-based browser and by again adding each product back into the interrupted e-tailer-specific virtual shopping cart 50 item by item until the nature and quantity of items in the e-tailer-specific virtual shopping cart 50 are identical as to the nature and the quantity of items as they appeared in the interim shopping cart 27, 28, 29 immediately prior to the interruption.

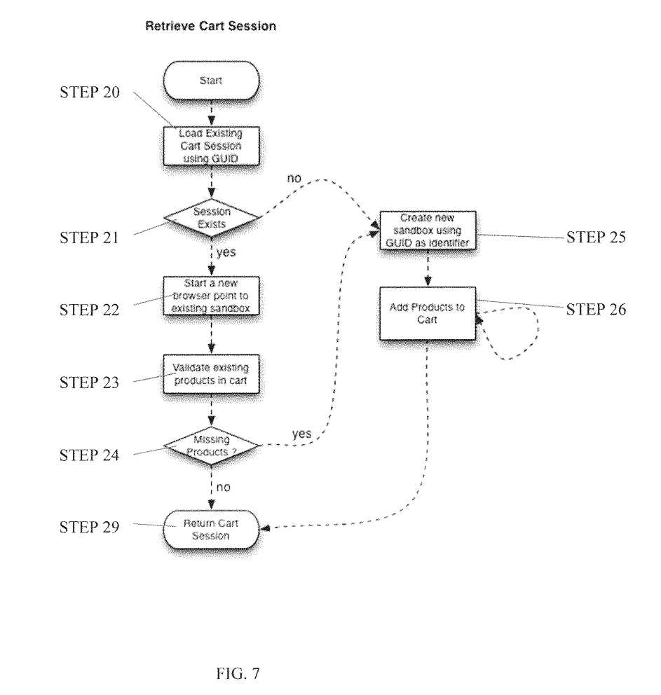

One aspect of a shopping cart retrieval/resurrection process is shown in FIG. 7. To facilitate virtual shopping cart 50 retrieval/resurrection, the system 10 may be structured and arranged to map, e.g., using a global unique identifier (GUID), every universal shopping cart shopping instance to an appropriate, corresponding e-tailer-specific virtual shopping cart 50 and/or to a list of the same. For example, each instance, e.g., add, delete, change quantity, and so forth, of the cloud-based browser corresponding to a discrete e-tailer-specific virtual shopping cart 50 may be assigned a unique GUID. Thus, each GUID may correspond to a unique interim retrieval shopping cart 27, 28, 29 for all or some temporal portion of a shopping session event. Advantageously, each instance of the cloud-based browser may be created using a completely sandboxed location on a disk, e.g., to store its cookie jar, its URL/UPI history, local and session storage, and so forth. More advantageously, the unique GUID/interim retrieval shopping cart 27, 28, 29 may be adapted to last for an indefinite period of time or for a definite period of time that is user configurable, configurable by the system 10, arbitrarily pre-established, and so forth.

Owing to this last described feature, one of the many advantages of this aspect of the system 10 is the capability of the system 10 to resurrect any recorded portion of a shopping session between the system 10 and a discrete e-tailer-specific virtual shopping cart 50 even though a significant amount of time has passed between shopping activity events, e.g., an amount of time sufficient to otherwise cause the corresponding e-tailer-specific virtual shopping cart 50 to terminate. This capability is particularly useful in instances in which the consumer 30 has changed his/her physical or geographical location and/or the processing device from which he/she began his/her shopping spree, e.g., from a tablet device at work to a home PC computer, which may require the passage of a significant length of time.

Referring to FIG. 7, the cart resurrection/retrieval process may first attempt to load existing cart session data (STEP 20), e.g., using the GUID/interim retrieval shopping carts 27, 28, 29. If the shopping cart session still exists at the e-tailer level (STEP 21), i.e., no interruption in communication, the cloud-based browser may point to the existing, uninterrupted e-tailer-specific virtual shopping cart 50 (STEP 22); validate the product information about each item in the virtual shopping cart 50 (STEP 23), e.g., by comparing data in the virtual shopping cart 50 with data in the GUID/interim retrieval shopping cart 28, 28, 29; and, if no products are missing (STEP 24) from the and the products are still available, these data have been retrieved and may be returned to the system 10 (STEP 29), e.g., the universal shopping cart 32.

In the event, however, that a shopping cart session involving a discrete e-tailer has been interrupted (STEP 21) or, alternatively, if validation (STEP 23) indicated that an item(s) found in the GUID/interim retrieval shopping cart 27, 28, 29 was not found in or was otherwise missing from the e-tailer-specific virtual shopping cart 50 (STEP 24), in each or either instance, the system 10 may be adapted to create a new e-tailer-specific virtual shopping cart 50 (STEP 25) on the e-tailer's website 11, 13, 15, e.g., using data from the corresponding GUID/interim retrieval shopping cart 27, 28, 29. Thus, each item recorded in the GUID/interim retrieval shopping cart 27, 28, 29 may be added to the e-tailer-specific virtual shopping cart 50 (STEP 26) until the contents of the GUID/interim retrieval shopping cart 27, 28, 29 and corresponding e-tailer-specific virtual shopping cart 50 match. When they do, these data may be returned to the system 10 (STEP 29), e.g., the universal shopping cart 32.

### Checkout

Once a consumer 30 manifests an intention to check out, e.g., by clicking on a “Confirm Order”, “Checkout”, “Pay”, and the like icon, the universal shopping cart 32 may be locked and the system 10 may proceed to check out, during which the system 10 completes a purchase transaction with each e-tailer having an item(s) in the universal shopping cart 32. For example, the system 10 may retrieve each cart session from where it left off during pricing, verifying anew that the products and product features/options are still available with the e-tailer and that the costs are the same as what was quoted to the consumer 30. The system 10 may then proceed to confirm and transact that portion of the whole order at each of the corresponding e-tailer's website. In some instances, a snapshot of the e-tailer's confirmation or shipping page 52 may be stored as a receipt or record of the transaction. The system 10 may also extract from an e-tailer's website 11, 13, 15 or web page some portion or all of the order information contained therein or thereon, e.g., an order number, expected arrival date, expected shipping date, shipping label numbers, and the like, for communication back to the consumer 30. E-tailers actively cooperate with the system 10 during this phase of the process, to ensure that the portion of the whole purchase order attributed to their e-tailer-specific virtual shopping cart 50 is placed on order, paid for by the consumer 30, and shipped to the consumer 30 as agreed to.

### System Architecture

It is understood that the methods and systems described below may contain software and hardware connected to the Internet via a network. Computing devices used to implement the systems and methods described herein are capable of communicating with each other via the Internet, and it should be appreciated that the various functionalities of the components may be implemented on any number of devices.

A communications network generally connects a client with a server, and in the case of peer-to-peer communications, connects two peers. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), and so on. Preferably, the network can carry TCP/IP protocol communications, and HTTP/HTTPS requests made by a web browser and the connection may be made between the peers and communicated over such TCP/IP networks.

The type of network is not a limitation, however, and any suitable network may be used. Non-limiting examples of networks that can serve as or be part of the communications network include a wireless or wired Ethernet-based intranet, a local or wide-area network (LAN or WAN), and/or the global communications network known as the Internet 16, which may accommodate many different communications media and protocols.

Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide such functionality, for example as a database management system which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Consumer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A consumer may enter commands and information into the computer through a consumer interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a consumer input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the consumer-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Although internal components of the computer are not shown, those of ordinary skill in the art will appreciate that such components and the interconnections are well known. Accordingly, additional details concerning the internal construction of the computer need not be disclosed in connection with the present invention.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

What we claim is:

1. A universal system for online commerce, the system comprising at least one data processing device that is adapted to execute computer-readable instructions contained in a memory, the at least one data processing device structured and arranged to:
provide at least one consumer interface to an application partner website at which a consumer can navigate to and through, without cooperation from the at least one e-tailer, at least one of a web page that is separate from an e-tailer-specific website and a web page provided by at least one e-tailer, for the purpose of displaying purchase and product information extracted from the e-tailer-specific website or the web page of the at least one e-tailer;
provide a universal shopping cart in the application partner website that is separate from an e-tailer-specific shopping cart, for storing at least one item offered for sale by the at least one e-tailer; and
transact a single checkout transaction with the consumer.

2. The system of claim 1, wherein the at last one data processing device is further adapted to maintain an integration with a discrete, e-tailer-specific shopping cart for each e-tailer having at least one item contained in the universal shopping cart.

3. The system of claim 1, wherein the universal shopping cart in the application partner website provides a summary of items that have been added at any time to any of the discrete, e-tailer-specific shopping carts for a period of time, a duration of which may be at least one of user configurable and configurable by the system.

4. The system of claim 1, wherein each of the at least one item is identified and searchable on any e-tailer's website using at least one of Universal Resource Locators and Universal Product Identification Numbers.

5. The system of claim 4, wherein the Universal Product Identification Numbers are selected from the group consisting of Universal Product Codes (UPC), International Article Number (EAN), Japanese Article Numbers (JAN), Global Trade Item Number (GTIN), and an internal, e-tailer-specific product number.

6. The system of claim 1 further comprising a spider application programming interface that (i) maintains integration with discrete e-tailers and retains product information for a period of time;
(ii) transacts the single checkout transaction with the consumer; and (iii) in response to instructions from the consumer, completes a purchase transaction with each discrete e-tailer.

7. The system of claim 6, wherein the spider application programming interface is adapted to maintain for a period of time shopping session data of a transaction state for each session of a plurality of discrete shopping sessions with a corresponding e-tailer.

8. The system of claim 7, wherein the spider application programming interface is adapted to regenerate the transaction state for any discrete shopping session that has expired, that has been canceled, interrupted, or that has been removed from records of the corresponding e-tailer.

9. The system of claim 8, wherein the spider application programming interface is adapted to regenerate the transaction state and to update the transaction state in accordance with real time product information extracted from the corresponding e-tailer.

10. The system of claim 9, wherein real time product information includes product availability, product descriptions, product reviews, return policies, coupon codes, product images, product color options, product size options or costs.

11. A method of completing a single checkout purchase transaction between an online consumer and a plurality of e-tailers, the method comprising:
providing a consumer with access to at least one application partner website at which the consumer views purchase and product information stored in a cache memory and extracted from any of the plurality of e-tailers websites without cooperation from the plurality of e-tailers;
providing a universal shopping cart on the at least one application partner website for storing and managing without cooperation from any of the plurality of e-tailers at least one item offered for sale by any of the plurality of e-tailers; and
providing real time product information until a transaction session is completed.

12. The method of claim 11 further comprising providing purchase and product information based on a consumer request using at least one of Universal Resource Locators and Universal Product Identification Numbers.

13. The method of claim 12, wherein the Universal Product Identification Numbers are selected from the group consisting of Universal Product Codes (UPC), International Article Number (EAN), Japanese Article Numbers (JAN), Global Trade Item Number (GTIN), and an internal, e-tailer-specific product number.

14. The method of claim 11 further comprising completing the purchase transaction with each of the plurality of e-tailers with at least one item contained in the universal shopping cart.

15. The method of claim 14, wherein completing the purchase transaction with each of the plurality of e-tailers includes at least one of:
retrieving a last purchase session state attributed to a discrete virtual shopping cart with the corresponding e-tailer;
validating the last purchase session state by ascertaining product availability with the corresponding e-tailer;
confirming completion of the purchase transaction;
extracting order confirmation information from the corresponding e-tailer; and
providing the consumer with the extracted order confirmation information.

16. The method of claim 14 further comprising applying any discounts or promotional coupons to the checkout purchase transaction.

17. The method of claim 11, wherein providing real time product information includes product information as to availability, product descriptions, product reviews, return policies, coupon codes, product images, color options, size options, and costs.

18. The method of claim 11,wherein providing a universal shopping cart on the at least one application partner website includes:
maintaining integration with each e-tailer-specific virtual shopping cart having at least one item contained in the universal shopping cart and
aggregating estimated costs from each of the e-tailer-specific shopping carts.

19. The method of claim 18 further comprising regenerating on a discrete e-tailer website a last purchase session state of the e-tailer-specific virtual shopping cart once the last purchase session state has been invalidated.

20. The method of claim 19, wherein regenerating a last purchase session state includes:
assigning a globally-unique identification reference number (GUID) to each instance of a session state attributed to the e-tailer-specific virtual shopping cart;
storing in memory the session state of the e-tailer-specific virtual shopping cart using the GUID;
retrieving the session state of the e-tailer-specific virtual shopping cart by using the GUID;
recreating the last purchase session state for the e-tailer-specific virtual shopping cart using the retrieved session state data; and
validating the last purchase session state by ascertaining product availability with the corresponding e-tailer.

21. An article of manufacture for completing a single checkout purchase transaction between an online consumer and a plurality of e-tailers, the article of manufacture comprising computer-readable program portions embedded thereon for completing the single checkout purchase transaction, the program portions comprising instructions for:
providing at least one application partner website at which a consumer can navigate to and through at least one web page that displays purchase and product information stored in a cache memory or extracted from any of the plurality of e-tailers without cooperation from the plurality of e-tailers;
providing a universal shopping cart on the at least one application partner website for storing and managing without cooperation from any of the plurality of e-tailers at least one item offered for sale by any of the plurality of e-tailers; and
providing real time product information until a transaction session is completed.
